(19) United States
(12) Patent Application Publication
(10) Pub. No.: US 2001/0052907 A1
(43) Pub. Date: Dec. 20, 2001

(54) Image merging apparatus and image merging method

(76) Inventors: Nobuhiko Mukai, Tokyo (JP); Katsunobu Muroi, Tokyo (JP)

Correspondence Address: BIRCH STEWART KOLASCH & BIRCH, PO BOX 747, FALLS CHURCH, VA, 22040-0747, US

(21) Appl. No.: 09/839,133

(22) Filed: Apr. 23, 2001

(30) Foreign Application Priority Data
Jun. 20, 2000 (JP) 2000-185215

(51) Int. Cl. G09G 5/00

(52) U.S. Cl. 345/629

(57) ABSTRACT

An image merging apparatus extracts noise included in a background image, and adds the noise to a CG image, thereby producing the merged image of the CG image and the background image. It can solve a problem of a conventional image merging apparatus in that although it can suppress the Mach band taking place in an edge segment, it brings about a mismatched feeling between the CG image and the background image when combining the shaded CG image and background image because it lacks a device for combining them taking account of the color difference between the CG image and the background image, or of the noise included in the background image.

### BACKGROUND OF THE INVENTION

1. Field of the Invention

The present invention relates to an image merging apparatus and an image merging method for producing a merged image of a CG image (computer graphics image) and a background image.

2. Description of Related Art

FIG. 10 is a block diagram showing a configuration of a conventional shading apparatus disclosed in Japanese patent application laid-open No. 8-212384/1996. In this figure, the reference numeral 1 designates a vertex luminance extractor for calculating color or luminance at vertices of a polygon to be shaded and its neighboring polygons; and 2 designates a luminance interpolator for calculating color or luminance inside the target polygon.

Next, the operation of the conventional shading apparatus will be described.

Receiving the normal vectors of the vertices of the target polygon to be shaded and its neighboring polygons, the vertex luminance extractor 1 calculates the color or luminance of the vertices from the normal vectors.

More specifically, assume that ΔI₁I₂I₃ is a target polygon in FIG. 11, then ΔI₁I₃I₄ becomes a neighboring polygon. The vertex luminance extractor 1 calculates the color or luminance at vertices of the target polygon ΔI₁I₂I₃ and the neighboring polygon ΔI₁I₃I₄, or the luminance in the ΔI₁I₂I₃ and ΔI₁I₃I₄.

When the vertex luminance extractor 1 calculates the color or luminance of the vertices of the target polygon and the neighboring polygon, the luminance interpolator 2 calculates the color or luminance inside the target polygon using the calculated results.

Specifically, it calculates the color or luminance I_{S1}, I_{S2} and I_{S3} at intersections of a scanning line 3 and the edges I₁I₂ I₁I₃ and I₁I₄ of the target polygon ΔI₁I₂I₃ and its neighboring polygon ΔI₁I₃I₄.

Subsequently, using the color or luminance at the three intersections, it calculates the color or luminance I at an internal point (X,Y) of the target polygon ΔI₁I₂I₃ as follows:

I_{S1}=I₁(Y_{S}−Y₂)/(Y₁−Y₂)+I₂(Y₁−Y_{S})/(Y₁−Y₂)

I_{S2}=I₁(Y_{S}−Y₃)/(Y₁−Y₃)+I₃(Y₁−Y_{S})/(Y₁−Y₃)

I_{S3}=I₁(Y_{S}−Y₄)/(Y₁−Y₄)+I₄(Y₁−Y_{S})/(Y₁−Y₄)

I=I_{S1}×Z₁+I_{S2}×Z₂+I_{S3}×Z₃

where

Z₁={(X−X_{S2})/(X_{S1}−X_{S2})}×{(X−X_{S3})/(X_{S1}−X_{S3})}

Z₂={(X−X_{S1})/(X_{S2}−X_{S1})}×{(X−X_{S3})/(X_{S2}−X_{S3})}

Z₃={(X−X_{S1})/(X_{S3}−X_{S1})}×{(X−X_{S2})/(X_{S3}−X_{S2})}

This method can avoid sharp changes in the gradient of the color or luminance on the edge segment I₁I₃, preventing the Mach band to take place on the edge segment I₁I₃.

Although the conventional shading apparatus with the foregoing configuration can suppress the Mach band on the edge segment I₁I₃, it presents a problem of producing a mismatched feeling between a CG image and a background image when merging the shaded CG image with the background image. This is because the conventional apparatus lacks a means for combining them considering the color difference between the CG image and background image, or noise Contained in the background image.

This will be described in more detail.

A composite picture is often produced by taking a picture of an object or scene in a real world to be used as a background, and by combining it with an image produced by the CG technique. For example, a simulation is often made to see whether a building or bridge which will be built from now matches the present scene of the spot, or to confirm whether the color of a new refrigerator to be installed in a room matches the room. In such cases, although the picture of the object or scene taken includes ambient noise, the image produced by the CG has a simple color tone without noise. Besides, since the color tone of the background picture can vary depending on the weather or time it is taken, it can differ from the image produced by the CG in the color tone, making it difficult to combine the background picture with the CG image. Although the conventional shading apparatus can suppress the Mach band, a sharp change in the gradient of the color or luminance involved in the shading, the color tone of the resultant image is usually monotonous including no ambient noise. In addition, it does not consider the color difference between the two images. Thus, the color difference between the CG image and the background presents a problem when they are combined.

### SUMMARY OF THE INVENTION

The present invention is implemented to solve the foregoing problems. It is therefore an object of the present invention to provide an image merging apparatus and an image merging method capable of implementing natural merging of a CG image and a background image without bringing about any mismatched feeling.

According to a first aspect of the present invention, there is provided an image merging apparatus for merging a CG (computer graphics) image and its background image to output a merged image, the image merging apparatus comprising: characteristic information output means for outputting information about a characteristic at least of the background image; and merged image producing means for producing the merged image of the CG image and the background image by adding output information of the characteristic information output means to the CG image.

Here, the characteristic information output means may comprise a noise extractor for extracting noise from the background image; and the merged image producing means may comprise a noise add-on section for adding the noise extracted by the noise extractor to the CG image to produce the merged image of the CG image and the background image.

The characteristic information output means may comprise a noise generator for generating noise corresponding to noise included in the background image; and the merged image producing means may comprise a noise add-on section for adding the noise generated by the noise generator to the CG image to produce the merged image of the CG image and the background image.

The characteristic information output means may comprise a color difference calculating section for calculating color difference between the CG image and the background image; and the merged image producing means may comprise color difference effecting section for causing the color difference calculated by the color difference calculating section to be reflected in at least one of the CG image and the background image, thereby producing the merged image of the CG image and the background image.

The noise add-on section may utilize the CG image that is being generated as an image to be processed.

The color difference calculating section and the color difference effecting section may utilize the CG image that is being generated as an image to be processed.

The image merging apparatus may use one of a still image and moving images as the background image.

According to a second aspect of the present invention, there is provided an image merging method of merging a CG (computer graphics) image and its background image to output a merged image, the image merging method comprising the steps of: outputting information about a characteristic at least of the background image; and producing the merged image of the CG image and the background image by adding the information about the characteristic to the CG image.

Here, the step of outputting information may extract noise from the background image; and the step of producing the merged image may add the noise extracted to the CG image to produce the merged image of the CG image and the background image.

The step of outputting information may generate noise corresponding to noise included in the background image; and the step of producing the merged image may add the noise generated to the CG image to produce the merged image of the CG image and the background image.

The step of outputting information may calculate color difference between the CG image and the background image; and the step of producing the merged image may cause the color difference calculated to be reflected in at least one of the CG image and the background image, thereby producing the merged image of the CG image and the background image.

The step of producing the merged image may utilize the CG image that is being generated as an image to be processed.

The image merging method may utilize the CG image that is being generated as an image to be processed.

The image merging method may use one of a still image and moving images as the background image.

### BRIEF DESCRIPTION OF THE DRAWINGS

FIG. 1 is a block diagram showing a configuration of an embodiment 1 of the image merging apparatus in accordance with the present invention;

FIG. 2 is a flowchart illustrating the image merging method of the embodiment 1;

FIG. 3 is a diagram illustrating an example of a background image;

FIG. 4 is a block diagram showing a configuration of an embodiment 2 of the image merging apparatus in accordance with the present invention;

FIG. 5 is a block diagram showing a configuration of an embodiment 3 of the image merging apparatus in accordance with the present invention;

FIG. 6 is a flowchart illustrating the image merging method of the embodiment 3;

FIG. 7 is a block diagram showing a configuration of an embodiment 4 of the image merging apparatus in accordance with the present invention;

FIG. 8 is a block diagram showing a configuration of an embodiment 5 of the image merging apparatus in accordance with the present invention;

FIG. 9 is a diagram illustrating a method of shading a triangle that constitutes basic CG shape data;

FIG. 10 is a block diagram showing a configuration of a conventional shading apparatus; and

FIG. 11 is a diagram illustrating a shading method.

### DETAILED DESCRIPTION OF THE PREFERRED EMBODIMENTS

The invention will now be described with reference to the accompanying drawings.

EMBODIMENT 1

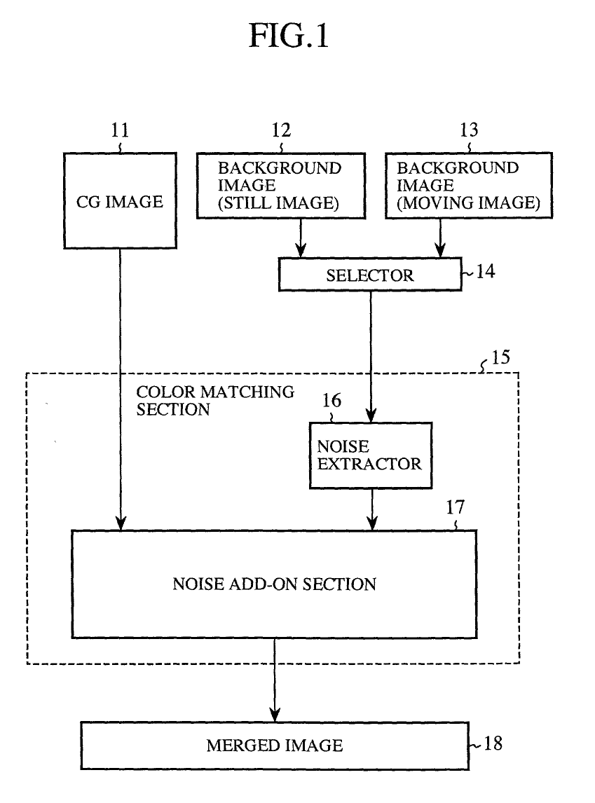

FIG. 1 is a block diagram showing a configuration of an embodiment 1 of the image merging apparatus in accordance with the present invention. In this figure, the reference numeral 11 designates a CG image generated by a computer graphics technique; 12 designates a background image, a still image such as a picture; 13 designates other background images, moving images such as video images; 14 designates a selector for selecting either the background image 12 or the background images 13; 15 designates a color matching section for matching color tone of the background image 12 or images 13 selected by the selector 14 with that of the CG image 11; 16 designates a noise extractor for extracting noise included in the background image 12 or images 13 selected by the selector 14; 17 designates a noise add-on section for adding the noise extracted by the noise extractor 16 to the CG image 11, thereby outputting a merged image 18 of the CG image 11 and the background image 12 or images 13; and 18 designates the merged image of the CG image 11 and the background image 12 or images 13.

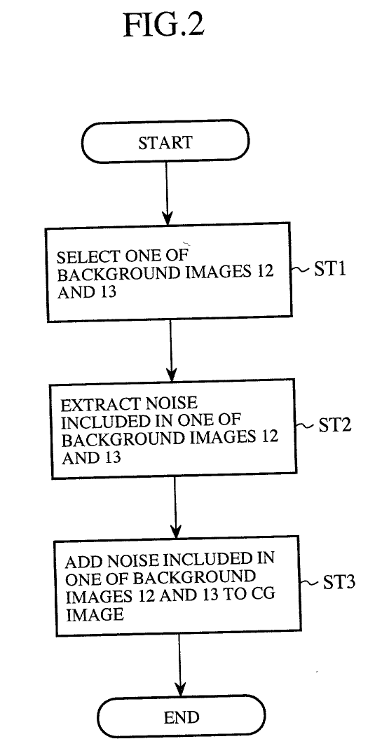

Next, the operation of the present embodiment 1 will be described with reference to FIG. 2 which is a flowchart illustrating the image merging method of the embodiment 1.

First, the selector 14 selects either the background image 12 or images 13 (step ST1). Specifically, the background image 12 consisting of a still picture and the background images 13 consisting of moving images are prepared in advance, and one of them is selected by a program, a menu selector or a switch. It is also possible to prepare one of them from the beginning, in which case the selector 14 can be removed. In the present embodiment 1, it is assumed that the selector 14 selects the background image 12 for convenience of explanation.

When the selector 14 selects the background image 12, the noise extractor 16 of the color matching section 15 extracts the noise from the background image 12 (step ST2).

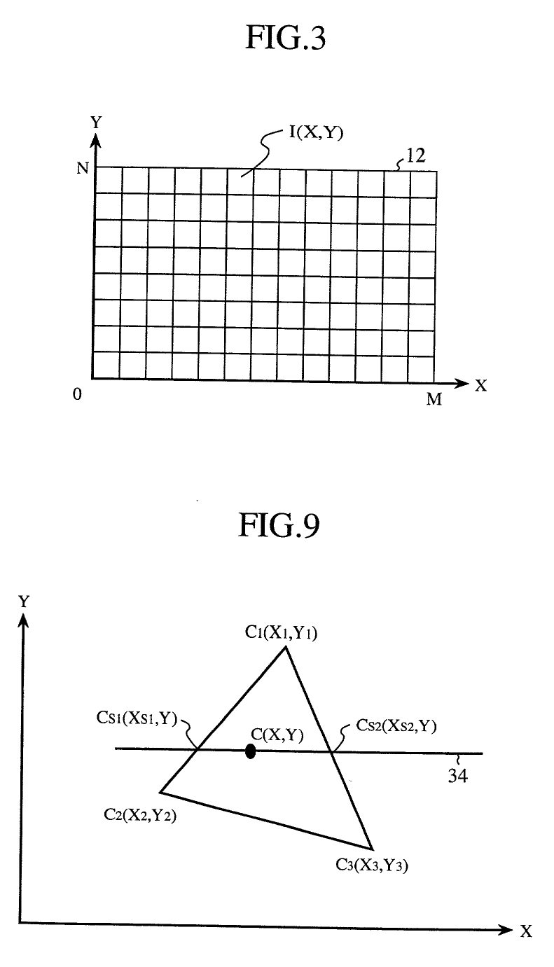

FIG. 3 is a diagram illustrating an example of the background image 12.

As illustrated in FIG. 3, the background image 12 has an image size of M (columns) × N (rows), and the pixel value at a given point (X,Y) is I(X,Y), where X denotes the horizontal coordinate and Y denotes the vertical coordinate.

As an example, it is assumed that I(X, Y) consists of RGB (red, green and blue), each of which consists of eight bits, and that least significant two bits of each eight bits represent image noise.

The noise of each of the RGB components I_{R}(X, Y), I_{G}(X, Y) and I_{B}(X,Y) of the I(X,Y) is expressed as follows:

noise of R component: I_{R}(X/Y) % 4

noise of G component: I_{G}(X/Y) % 4

noise of B component: I_{B}(X/Y) % 4 (1)

where % is an operator for obtaining a remainder. Thus, A % B represents the remainder when A is divided by B.

Generally, when least significant b bits represent the noise, the noise component of the I(X,Y) is represented as I (X,Y) % (2^{Λ}b), where is an operator representing the power. Thus, A^{Λ}B represents the B-th power of A.

When the noise extractor 16 extracts the noise from the background image 12, the noise add-on section 17 adds the noise to the CG image 11, and outputs the merged image 18 of the CG image 11 and the background image 12 (step ST3).

This will be described in more detail.

To add the noise extracted by the noise extractor 16 to the CG image 11, it is necessary to extract a portion unrelated to the noise from the CG image 11.

Let us assume that the CG image 11 has an image size of M (columns)×N (rows) like the background image 12, and is composed of RGB components, each of which consists of eight bits, that C(X,Y) represents the pixel value at a given point (X,Y) of the CG image 11, and that the RGB components of the C(X,Y) are denoted as C_{R}(X,Y), C_{G}(X,Y) and C_{B}(X,Y), respectively. As described above, since the least significant two bits are assumed to represent noise in the present embodiment 1, the portion unrelated too the noise can be calculated from the C(X,Y) as follows:

noise of R component: [C_{R}(X,Y)/4]×4

noise of G component: [C_{G}(X,Y)/4]×4

noise of B component: [C_{B}(X,Y)/4]×4 (2)

where [A] represents an integer-valued function representing the nearest integer obtained by dropping the fractional portion of the number. Generally, the component unrelated to the nose of the C(X,Y) is represented as [C(X,Y)/(2^{Λ}b)]×(2^{Λ}b) when the least significant b bits indicate the noise.

Thus, the noise-unrelated component of the CG image 11 and the noise component of the background image 12 can be obtained by the foregoing calculations. Accordingly, by summing them up, the noise of the background image 12 can be added to the CG image 11.

The resultant merged image 18 produced by the noise add-on section 17 can be represented as follows:

R component of merged image 18:

[C_{R}(X,Y)/(2^{Λ}b)]×(2^{Λ}b)+I_{R}(X,Y)%(2^{Λ}b)

G component of merged image 18:

[C_{G}(X,Y)/(2^{Λ}b)]×(2^{Λ}b)+I_{G}(X,Y)%(2^{Λ}b)

B component of merged image 18:

[C_{B}(X,Y)/(2^{Λ}b)]×(2^{Λ}b)+I_{B}(X,Y)%(2^{Λ}b) (3)

As described above, the present embodiment 1 is configured such that it extracts the noise from the background image 12, and adds it to the CG image 11 to produce the merged image 18 of the CG image 11 and the background image 12. Therefore, it offers an advantage of being able to implement natural merging of the CG image 11 and the background image 12 without bringing about the mismatched feeling.

EMBODIMENT 2

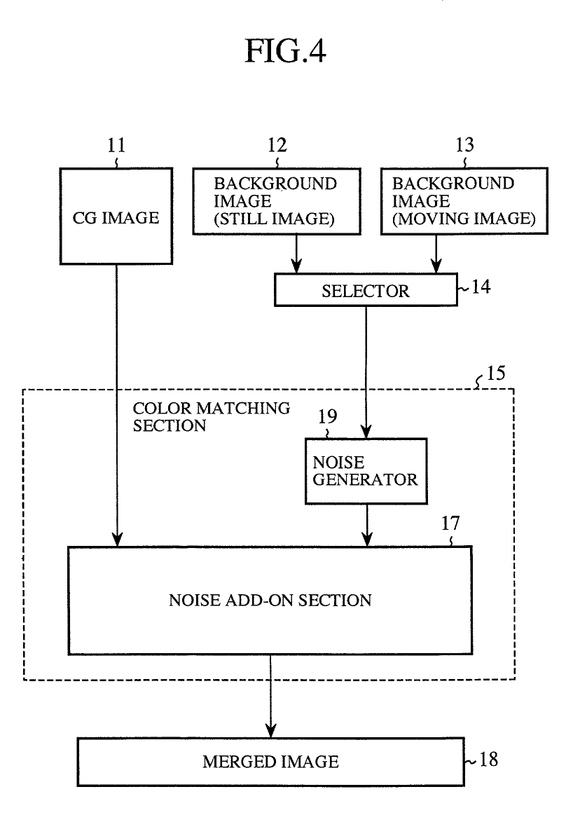

FIG. 4 is a block diagram showing a configuration of an embodiment 2 of the image merging apparatus in accordance with the present invention. In FIG. 4, the same reference numerals designate the same or like portions to those of FIG. 1, and the description thereof is omitted here.

In FIG. 4, the reference numeral 19 designates a noise generator for generating noise corresponding to the noise included in the background image 12 or images 13.

Next, the operation of the present embodiment 2 will be described.

Although the foregoing embodiment 1 comprises the noise extractor 16 for extracting the noise included in the background image 12 or images 13, it is not essential. The present embodiment 2 comprises the noise generator 19 for generating the noise corresponding to the noise included in the background image 12 or images 13. Here, the noise generator 19 can generate the noise with or without utilizing the background image 12 or images 13.

First, a method will be described in which the noise generator 19 produces noise without using the background image 12 or images 13.

Using a function F that generates decimal fractions at random from 0.0 to 1.0, the noise generated can be defined by [F×(2^{Λ}b)]. Therefore, according to equations (3), the individual components of the merged image 18 can be represented as follows:

R component of merged image 18:

[C_{R}(X,Y)/(2^{Λ}b)]×(2^{Λ}b)+[F×(2^{Λ}b)]

G component of merged image 18:

[C_{G}(X,Y)/(2^{Λ}b)]×(2^{Λ}b)+[F×(2^{Λ}b)]

B component of merged image 18:

[C_{B}(X,Y)/(2^{Λ}b)]×(2^{Λ}b)+[F×(2^{Λ}b)] (4)

Since the function F generates a different value each time activated, all the noise values of the components differ from each other. To insert the same noise value intentionally, the function F is activated once, and the generated value is held to be used repeatedly. In this case, the following notations hold.

R component of merged image 18:

[C_{R}(X,Y)/(2^{Λ}b)]×(2^{Λ}b)+NOISE

G component of merged image 18:

[C_{G}(X,Y)/(2^{Λ}b)]×(2^{Λ}b)+NOISE

B component of merged image 18:

[C_{B}(X,Y)/(2^{Λ}b)]×(2^{Λ}b)+NOISE

where NOISE=[F×(2^{Λ}b)] (5)

Although this example generates the noise utilizing the random function, any functions are applicable as long as they can define noise. For example, trigonometric functions, exponential functions and the like, or the combinations thereof can be used. Alternatively, the combinations of these functions and the random function are also possible.

Next, the method will be described when the noise generator 19 produces noise using the background image 12.

The noise generator 19 extracts the noise components from the individual components of the background image 12 according to equation (1), and examines the characteristics of the noise components such as the mean, variance and periodicity.

Then, the noise generator 19 generates a function matching the noise characteristics by combining the random function, trigonometric functions, exponential functions and the like. The generated function basically corresponds to the pixel position of the background image 12, and is represented as G(X,Y) An example of the noise generating functions obtained for the respective RGB components is as follows:

G_{R}(X,Y)=M_{R}×(Sin(X)+Sin(Y))/2

G_{G}(X,Y)=M_{G}×(Sin(X)+Sin(Y))/2

G_{B}(X,Y)=M_{B}×(Sin(X)+Sin(Y))/2 (6)

where

M_{R}: mean value of noise component of I_{R}(X,Y)

M_{G}: mean value of noise component of I_{G}(X,Y)

M_{B}: mean value of noise component of I_{B}(X,Y)

Using these functions allows the components of the merged image 18 to be expressed as follows:

R component of merged image 18:

[C_{R}(X,Y)/(2^{Λ}b)]×(2^{Λ}b)+G_{R}(X,Y)

G component of merged image 18:

[C_{G}(X,Y)/(2^{Λ}b)]×(2^{Λ}b)+G_{G}(X,Y)

B component of merged image 18:

[C_{B}(X,Y)/(2^{Λ}b)]×(2^{Λ}b)+G_{B}(X,Y) (7)

Although the noise generator 19 generates the noise utilizing the background image 12, it can generate the noise in the same manner using the background images 13, the moving images, instead of the background image 12. In this case, however, since the background images 13 includes multiple images, an increasing number of factors that express the noise characteristics such as correlation between background images and the mean values with regard to all the images will offer a wide choice of options of the noise generating function.

According to the present embodiment 2, it can generate noise without using the background image 12 or images 13. When using the background image 12 or images 13, it can generate the noise taking account of the noise characteristics of the background image 12 or images 13, which allows natural merging of the CG image 11 and the background image 12 or images 13.

EMBODIMENT 3

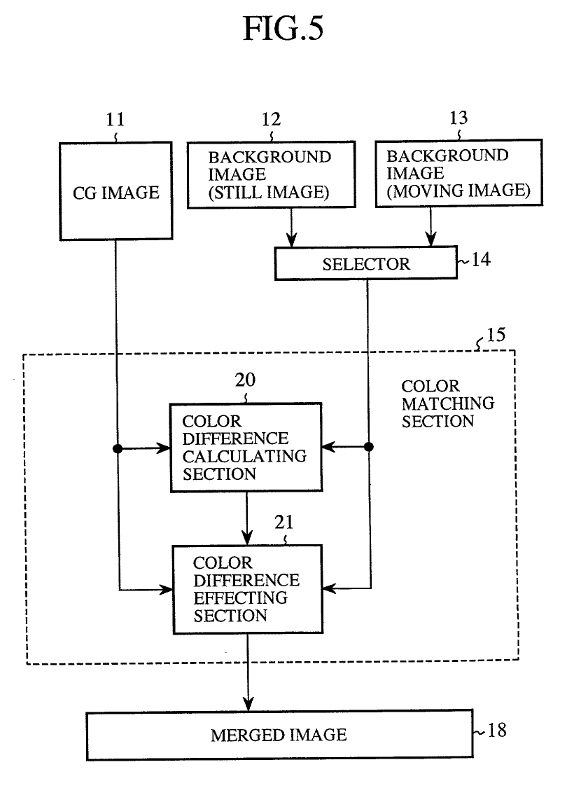

FIG. 5 is a block diagram showing a configuration of an embodiment 3 of the image merging apparatus in accordance with the present invention. In this figure, the same reference numerals designate the same or like portions to those of FIG. 1, and the description thereof is omitted here.

In FIG. 5, the reference numeral 20 designates a color difference calculating section for calculating the color difference between the CG image 11 and the background image 12 or images 13 selected by the selector 14; and 21 designates a color difference effecting section for causing the color difference calculated by the color difference calculating section 20 to be reflected in the CG image 11, or the background image 12 or images 13, thereby producing the merged image 18 of the CG image 11 and the background image 12 or images 13.

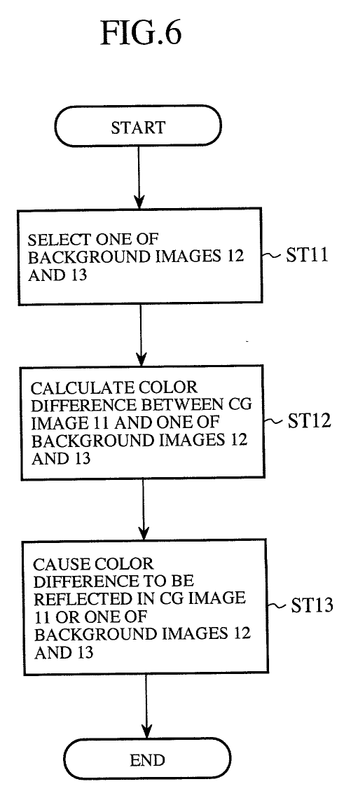

Next, the operation of the present embodiment 3 will be described with reference to FIG. 6, a flowchart illustrating the image merging method in the present embodiment 3.

First, the selector 14 selects either the background image 12 or the background images 13 (step ST11). For convenience of explanation, the present embodiment 3 assumes that the selector 14 selects the background image 12.

When the selector 14 selects the background image 12, the color difference calculating section 20 calculates the color difference between the CG image 11 and the background image 12 (step ST12).

Specifically, it calculates the mean values of the RGB components I_{R}(X,Y), I_{G}(X,Y) and I_{B}(X,Y) of the background image 12 in the neighborhood of the point (X,Y), and the mean values of the RGB components C_{R}(X,Y), C_{G}(X,Y) and C_{B}(X,Y) of the CG image 11 in the neighborhood of the point (X,Y), and then obtains the differences between the mean values as the color difference.

D_{R}(X,Y)=MI_{R}(X,Y)−MC_{R}(X,Y)

D_{G}(X,Y)=MI_{G}(X,Y)−MC_{G}(X,Y)

D_{B}(X,Y)=MI_{B}(X,Y)−MC_{B}(X,Y) (8)

where

MI_{R}(X,Y) : mean value of I_{R} in m×n neighborhood of (X,Y)

MI_{G}(X,Y) : mean value of I_{G} in m×n neighborhood of (X,Y)

MI_{B}(X,Y) : mean value of I_{B} in m×n neighborhood of (X,Y)

MC_{R}(X,Y) : mean value of C_{R} in m×n neighborhood of (X,Y)

MC_{G}(X,Y) : mean value of C_{G} in m×n neighborhood of (X,Y)

MC_{B}(X,Y) : mean value of C_{B} in m×n neighborhood of (X,Y)

When the color difference calculating section 20 calculates the color difference, the color difference effecting section 21 causes the color difference to be reflected in the CG image 11 or the background image 12, thereby producing the merged image 18 of the CG image 11 and the background image 12 (step ST13)

R component of CG image 11 merged with background image 12:

C_{R}(X,Y)+D_{R}(X,Y)

G component of CG image 11 merged with background image 12:

C_{G}(X,Y)+D_{G}(X,Y)

B component of CG image 11 merged with background image 12:

C_{B}(X,Y)+D_{B}(X,Y) (9)

R component of background image 12 merged with CG image 11:

I_{R}(X,Y)−D_{R}(X,Y)

G component of background image 12 merged with CG image 11:

I_{G}(X,Y)−D_{G}(X,Y)

B component of background image 12 merged with CG image 11:

I_{B}(X,Y)−D_{B}(X,Y) (10)

Here, if each pixel value obtained as a result of the calculation exceeds the maximum value of the pixel values, it is set at the maximum value, whereas if it is less than the minimum value thereof it is set at the minimum value.

Incidentally, it is enough for the color difference effecting section 21 to calculate one of equations (9) and (10) without calculating both of them. Usually, since the CG image 11 is adjusted to the color tone of the background image 12, equation (9) is calculated. In contrast, when the background image 12 is adjusted to the color tone of the CG image 11, equation (10) is calculated.

Although the present embodiment 3 utilizes the background image 12, it can also use the background images 13, the moving images, in place of the background image 12 in the same manner. In this case, since the background images 13 include multiple pictures, the color difference can be calculated for each background image, or for a set of multiple background images.

As described above, the present embodiment 3 is configured such that it calculates the color difference between the CG image 11 and the background image 12, and causes the color difference to be reflected in the CG image 11 or the background image 12. As a result, it can offer an advantage of being able to implement natural merging of the CG image 11 and the background image 12 without bringing about the mismatched feeling.

EMBODIMENT 4

Although the foregoing embodiments 1 and 2 add noise to the CG image 11, and the foregoing embodiment 3 causes the color difference to be reflected in the CG image 11 or the background image 12, both the noise addition processing and color difference reflecting processing can be carried out on the CG image 11 and background image 12.

More specifically, when the selector 14 selects the background image 12, and the noise extractor 16 extracts the noise from the background image 12, the processings according to equations (3), (8) and (9) are carried out. The RGB components of the CG image 11 merged with the background image 12 are described as follows:

R component of merged CG image:

[C_{R}(X,Y)/(2^{Λ}b)]×(2^{Λ}b)+I_{R}(X,Y) %(2^{Λ}b)+D_{R}(X,Y)

G component of merged CG image:

[C_{G}(X,Y)/(2^{Λ}b)]×(2^{Λ}b)+I_{G}(X,Y) %(2^{Λ}b)+D_{G}(X,Y)

B component of merged CG image:

[C_{B}(X,Y)/(2^{Λ}b)]×(2^{Λ}b)+I_{B}(X,Y) %(2^{Λ}b)+D_{B}(X,Y) (11)

When the noise generator 19 is used instead of the noise extractor 16, a similar description is obtained according to equations (4)-(9). When the background images 13 consisting of the moving images are used in place of the background image 12, the basic scheme is the same in spite of the plurality of images.

According to the present embodiment 4, it not only adds the noise extracted from the background image to the CG image 11, but also calculates the color difference between the CG image 11 and the background image 12 or the like to adjust the color tone of the CG image 11 to that of the background image 12 or the like. Thus, it can implement more natural merging of the CG image 11 with the background image 12 or the like.

EMBODIMENT 5

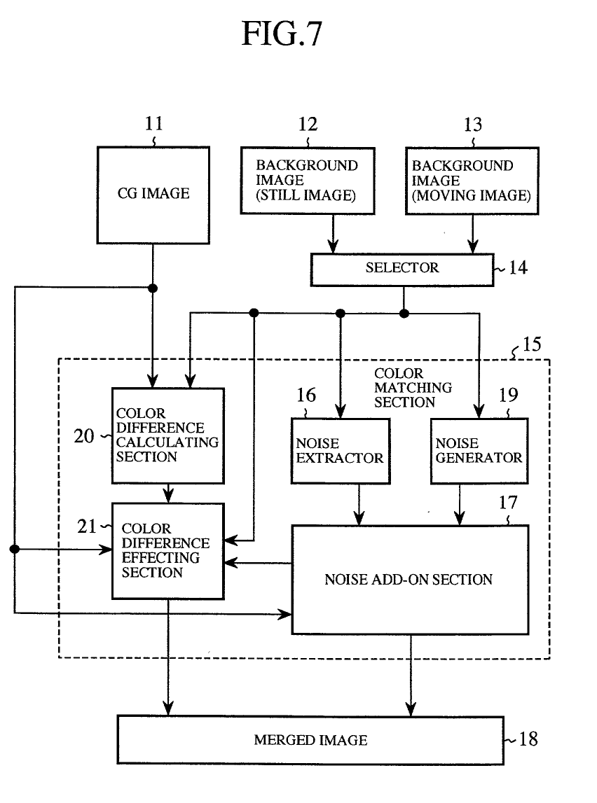

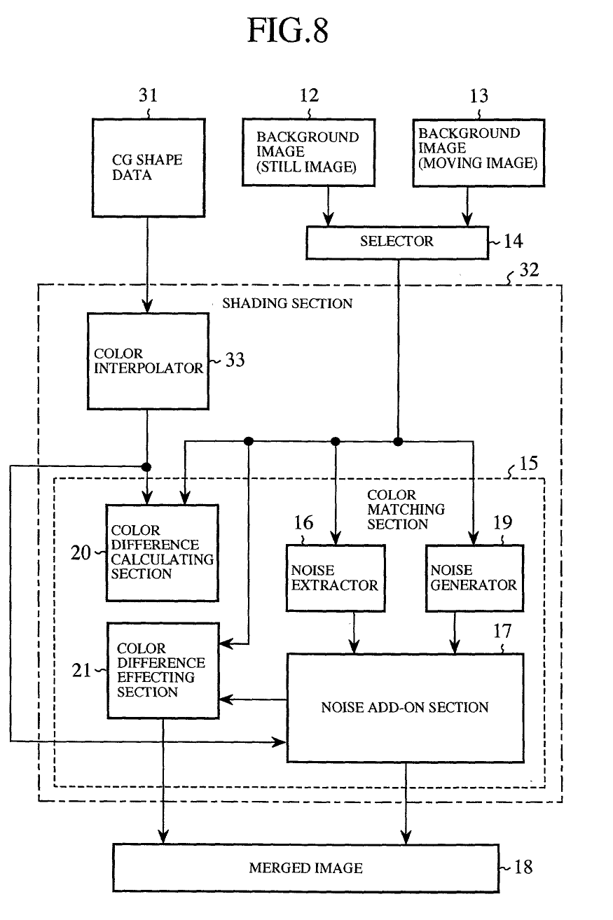

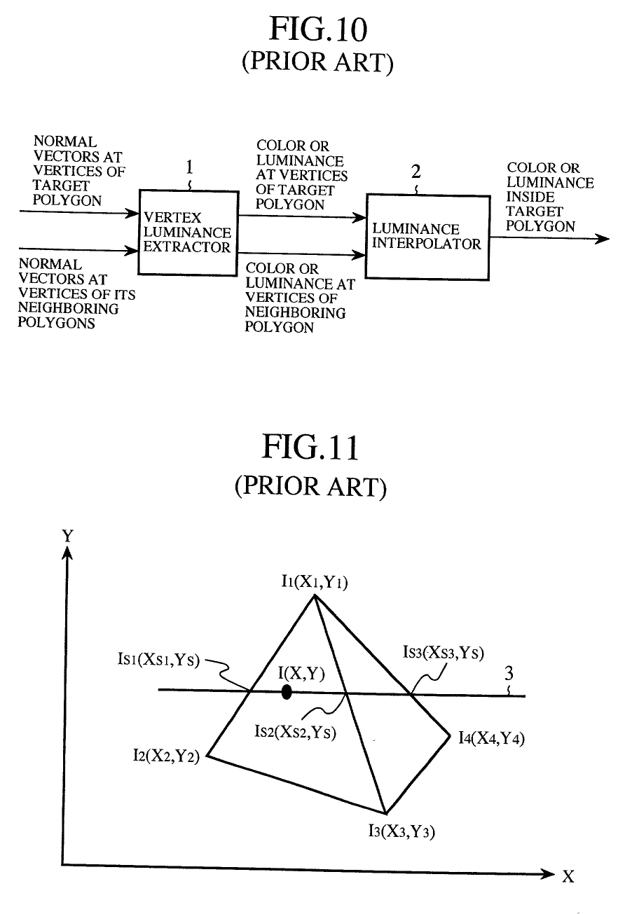

FIG. 8 is a block diagram showing a configuration of an embodiment 5 of the image merging apparatus in accordance with the present invention. In this figure, the same reference numerals designate the same or like portions to those of FIG. 7, and the description thereof is omitted here.

In FIG. 8, the reference numeral 31 designates CG shape data from which the CG image is generated; 32 designates a shading section needed for generating the CG image; and 33 designates a color interpolator that performs a basic operation for generating the color of the CG image.

Although the color matching section 15 is applied to the CG image 11 that has already been produced in the foregoing embodiments 1-4, it can be incorporated into a shading section 32 for generating the CG image 11 instead. Here, an example will be described in which the color matching section 15 is incorporated into the shading section 32 for generating the CG image.

Next, the operation of the present embodiment 5 will be described.

FIG. 9 is a diagram illustrating a shading method of a triangle, a basic element of the CG shape data 31. In this figure, the reference numeral 34 designates a scanning line. Usually, colors at the vertices C₁, C₂ and C₃ are calculated from the normal vectors, light source vectors and color attributes of the triangle (ambient light component, diffuse reflection light component and mirror reflection light component) at the individual vertices (for details, see, Japanese patent application laid-open No. 8-212384/1996 described as the prior art, which is incorporated here by reference).

Subsequently, the colors (C_{S1}, C_{S2}) at the intersections of the scanning line 34 and the edges C₁C₂ and C₁C₃ are calculated as follows by the linear interpolation between C₁ and C₂, and C₁ and C₃.

C_{S1}(X,Y)={C₁(Y−Y₂)+C₂(Y₁−Y)}/(Y₁−Y₂)

C_{S2}(X,Y)={C₁(Y−Y₃)+C₃(Y₁−Y)}/(Y₁−Y₃) (12)

Then, the color C at a given point (X,Y) inside the triangle is obtained as follows from the C_{S1} and C_{S2}.

C(X,Y)={C_{S1}(X_{S2}−X)+C_{S2}(X−X_{S1})}/(X_{S2}−X_{S1}) (13)

where the color is handled in its entirety without resolving it into the RGB components in equations (12) and (13).

Here, the mean values in the m×n neighborhood of the point (X,Y) in equation (8) are calculated as follow:

MI_{R}(X,Y): mean value of I_{R} in m×n neighborhood of (X,Y)

MI_{G}(X,Y): mean value of I_{G} in m×n neighborhood of (X,Y)

MI_{B}(X,Y): mean value of I_{B} in m×n neighborhood of (X,Y)

where m=MAX(X₁, X₂, X₃)-MIN(X₁, X₂, X₃)

n=MAX(Y₁, Y₂, Y₃)-MIN(Y₁, Y₂, Y₃) (14)

where MAX is a function for obtaining the maximum value of the arguments, and MIN is a function for obtaining the minimum value of the arguments.

MC_{R}(X,Y)=(C_{1R}+C_{2R}+C_{3R})/3

MC_{G}(X,Y)=(C_{1G}+C_{2G}+C_{3G})/3

MC_{B}(X,Y)=(C_{1B}+C_{2B}+C_{3B})/3

From the foregoing results, the merged image 18 is obtained as the following expression (15), when the color matching section 15 is incorporated into the shading section 32.

R component of merged CG image:

[C_{R}(X,Y)/(2^{Λ}b)]×(2^{Λ}b)+I_{R}(X,Y) %(2^{Λ}b)+D_{R}(X,Y)

G component of merged CG image:

[C_{G}(X,Y)/(2^{Λ}b)]×(2^{Λ}b)+I_{G}(X,Y) %(2^{Λ}b)+D_{G}(X,Y)

B component of merged CG image:

[C_{B}(X,Y)/(2^{Λ}b)]×(2^{Λ}b)+I_{B}(X,Y) %(2^{Λ}b)+D_{B}(X,Y) (15)

where

C_{R}(X,Y)={C_{S1R}(X_{S2}−X)+C_{S2R}(X−X_{S1})}/(X_{S2}−X_{S1})

C_{G}(X,Y)={C_{S1G}(X_{S2}−X)+C_{S2G}(X−X_{S1})}/(X_{S2}−X_{S1})

C_{B}(X,Y)={C_{S1B}(X_{S2}−X)+C_{S2B}(X−X_{S1})}/(X_{S2}−X_{S1})

C_{S1R}(X,Y)={C_{1R}(Y−Y₂)+C_{2R}(Y₁−Y)}/(Y₁−Y₂)

C_{S1G}(X,Y)={C_{1G}(Y−Y₂)+C_{2G}(Y₁−Y)}/(Y₁−Y₂)

C_{S1B}(X,Y)={C_{1B}(Y−Y₂)+C_{2B}(Y₁−Y)}/(Y₁−Y₂)

C_{S2R}(X,Y)={C_{1R}(Y−Y₃)+C_{3R}(Y₁−Y)}/(Y₁−Y₃)

C_{S2G}(X,Y)={C_{1G}(Y−Y₃)+C_{3G}(Y₁−Y)}/(Y₁−Y₃)

C_{S2B}(X,Y)={C_{1B}(Y−Y₃)+C_{3B}(Y₁−Y)}/(Y₁−Y₃)

I_{R}(X,Y): R component of background image 12

I_{G}(X,Y): G component of background image 12

I_{B}(X,Y): B component of background image 12

D_{R}(X,Y)=MI_{R}(X,Y)−MC_{R}(X,Y)

D_{G}(X,Y)=MI_{G}(X,Y)−MC_{G}(X,Y)

D_{B}(X,Y)=MI_{B}(X,Y)−MC_{B}(X,Y)

MI_{R}(X,Y): mean value of I_{R} in m×n neighborhood of (X,Y)

MI_{G}(X,Y): mean value of I_{G} in m×n neighborhood of (X,Y)

MI_{B}(X,Y): mean value of I_{B} in m×n neighborhood of (X,Y)

where m=MAX(X₁, X₂, X₃)−MIN(X₁, X₂, X₃)

n=MAX(Y₁, Y₂, Y₃)−MIN(Y₁, Y₂, Y₃)

MC_{R}(X,Y)=(C_{1R}+C_{2R}+C_{3R})/3

MC_{G}(X,Y)=(C_{1G}+C_{2G}+C_{3G})/3

MC_{B}(X,Y)=(C_{1B}+C_{2B}+C_{3B})/3

As described above, the color matching section 15 can not only be applied to the CG image 11 that has already been generated, but also be incorporated into the shading section 32 for generating the CG image 11. Thus, the present embodiment 5 can quickly implement the merged image 18 of the images such as the CG image 11 and the background image 12, without impairing the natural feeling.

What is claimed is:

1. An image merging apparatus for merging a CG (computer graphics) image and its background image to output a merged image, said image merging apparatus comprising:
characteristic information output means for outputting information about a characteristic at least of the background image; and
merged image producing means for producing the merged image of the CG image and the background image by adding output information of said characteristic information output means to the CG image.

2. The image merging apparatus according to claim 1, wherein said characteristic information output means comprises a noise extractor for extracting noise from the background image; and said merged image producing means comprises a noise add-on section for adding the noise extracted by said noise extractor to the CG image to produce the merged image of the CG image and the background image.

3. The image merging apparatus according to claim 1, wherein said characteristic information output means comprises a noise generator for generating noise corresponding to noise included in the background image; and said merged image producing means comprises a noise add-on section for adding the noise generated by said noise generator to the CG image to produce the merged image of the CG image and the background image.

4. The image merging apparatus according to claim 1, wherein said characteristic information output means comprises a color difference calculating section for calculating color difference between the CG image and the background image; and said merged image producing means comprises color difference effecting section for causing the color difference calculated by said color difference calculating section to be reflected in at least one of the CG image and the background image, thereby producing the merged image of the CG image and the background image.

5. The image merging apparatus according to claim 2, wherein said characteristic information output means further comprises a color difference calculating section for calculating color difference between the CG image and the background image; and said merged image producing means further comprises a color difference effecting section for causing the color difference calculated by said color difference calculating section to be reflected in at least one of the CG image and the background image.

6. The image merging apparatus according to claim 2, wherein said noise add-on section utilizes the CG image that is being generated as an image to be processed.

7. The image merging apparatus according to claim 3, wherein said characteristic information output means further comprises a color difference calculating section for calculating color difference between the CG image and the background image; and said merged image producing means further comprises a color difference effecting section for causing the color difference calculated by said color difference calculating section to be reflected in at least one of the CG image and the background image.

8. The image merging apparatus according to claim 3, wherein said noise add-on section utilizes the CG image that is being generated as an image to be processed.

9. The image merging apparatus according to claim 4, wherein said color difference calculating section and said color difference effecting section utilize the CG image that is being generated as an image to be processed.

10. The image merging apparatus according to claim 1, using one of a still image and moving images as the background image.

11. An image merging method of merging a CG (computer graphics) image and its background image to output a merged image, said image merging method comprising the steps of:
outputting information about a characteristic at least of the background image; and
producing the merged image of the CG image and the background image by adding the information about the characteristic to the CG image.

12. The image merging method according to claim 11, wherein the step of outputting information extracts noise from the background image; and the step of producing the merged image adds the noise extracted to the CG image to produce the merged image of the CG image and the background image.

13. The image merging method according to claim 11, wherein the step of outputting information generates noise corresponding to noise included in the background image; and the step of producing the merged image adds the noise generated to the CG image to produce the merged image of the CG image and the background image.

14. The image merging method according to claim 11, wherein the step of outputting information calculates color difference between the CG image and the background image; and the step of producing the merged image causes the color difference calculated to be reflected in at least one of the CG image and the background image, thereby producing the merged image of the CG image and the background image.

15. The image merging method according to claim 12, wherein the step of outputting information further calculates color difference between the CG image and the background image; and the step of producing the merged image further causes the color difference calculated to be reflected in at least one of the CG image and the background image.

16. The image merging method according to claim 12, wherein the step of producing the merged image utilizes the CG image that is being generated as an image to be processed.

17. The image merging method according to claim 13, wherein the step of outputting information further calculates color difference between the CG image and the background image; and the step of producing the merged image further causes the color difference calculated to be reflected in at least one of the CG image and the background image.

18. The image merging method according to claim 13, wherein the step of producing the merged image utilizes the CG image that is being generated as an image to be processed.

19. The image merging method according to claim 14, utilizing the CG image that is being generated as an image to be processed.

20. The image merging method according to claim 11, using one of a still image and moving images as the background image.
